(19) United States
(12) Patent Application Publication
(10) Pub. No.: US 2017/0041734 A1
(43) Pub. Date: Feb. 9, 2017

(54) PORTABLE TERMINAL APPARATUS AND CONTROL METHOD THEREOF

(71) Applicant: Samsung Electronics Co., Ltd., Suwon-si (KR)

(72) Inventors: Joon-seop OH, Paju-si (KR); Young-jin KIM, Yongin-si (KR); Hyun-jae SHIN, Seoul (KR); Young-min WON, Suwon-si (KR); Sang-ung YI, Suwon-si (KR); Seung-ho JUNG, Suwon-si (KR)

(21) Appl. No.: 15/012,243

(22) Filed: Feb. 1, 2016

(30) Foreign Application Priority Data
Aug. 5, 2015 (KR) 10-2015-0110412

(51) Int. Cl. H04W 4/00; H04W 60/00

(52) U.S. Cl. CPC H04W 4/005; H04W 60/00; H04W 84/18

(57) ABSTRACT

A portable terminal apparatus and a control method thereof are provided. The portable terminal apparatus includes a communication part configured to perform data communication with at least one electronic device, an input part configured to receive a user command, and a controller configured to set an event condition from a sensing value received from the at least one electronic device when a first user command is input through the input part, and set an event execution command matched to the event condition from execution state information received from the at least one electronic device when a second user command is input through the input part. Thus, the portable terminal apparatus may easily and quickly set an automation rule related to Internet of things (IOT) services.

### CROSS-REFERENCE TO RELATED APPLICATION(S)

This application claims the benefit under 35 U.S.C. §119(a) of a Korean patent application filed on Aug. 5, 2015 in the Korean Intellectual Property Office and assigned Serial No. 10-2015-0110412, the entire disclosure of which is hereby incorporated by reference.

### TECHNICAL FIELD

The present disclosure relates to a portable terminal apparatus and a control method thereof. More particularly, the present disclosure relates to a portable terminal apparatus for providing Internet of things (IOT) services, and a control method thereof.

### BACKGROUND

Based on the development of Internet communication, an interest in Internet of things (IOT) services, which allow for the exchange of information between electronic devices through the wired/wireless Internet and provide automation services on the basis of the exchanged information, has grown. Accordingly, research into the IOT services have been actively conducted. Thus, recently developed electronic devices support communication modules, platforms, and service functions for IOT services, allowing for the sharing of information between electronic devices.

Existing IOT services are provided in such a manner that they must be executed according to automation service rules predefined by manufacturers. Thus, users must be fully aware of information related to automation service rules defined by the manufacturers.

In order to address this problem, a scheme of providing an IOT service through an automation service rule set by each user has been sought. However, stages for generating automation service rules described above are so complicated that IOT services cannot be effectively used.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method for effectively using an Internet of things (IOT) service.

Another aspect of the present disclosure is to provide a method for easily and quickly setting an automation service rule for an IOT service.

In accordance with an aspect of the present disclosure, a portable terminal apparatus is provided. The portable terminal apparatus includes a communication part configured to perform data communication with at least one electronic device, an input part configured to receive a user command, and a controller configured to set an event condition from a sensing value received from the at least one electronic device when a first user command is input through the input part, and set an event execution command matched to the event condition from execution state information received from the at least one electronic device when a second user command is input through the input part.

When the first user command is input, the controller may analyze the sensing value received from the at least one electronic device until a time that the second user command is input, to determine an electronic device in which an event has occurred, and set pattern information generated from a sensing value received from the electronic device in which the event has occurred, to the event condition.

After the first user command is input, when a user motion is input through the input part, the controller may set pattern information generated from the user motion to the event condition.

The portable terminal apparatus may further include a storage configured to store condition information corresponding to a preset uttered voice for each of the at least one electronic device, wherein, when voice information regarding a voice uttered by a user is input through the input part after the first user command is input, the controller may extract condition information related to the voice information from the storage, and set the extracted condition information to the event condition.

When execution state information related to an operation execution of an electronic device is received from the at least one electronic device within a preset threshold time after the second user command is input, the controller may set an event execution command matched to the event condition from the received execution state information.

The portable terminal apparatus may further include a storage configured to store execution state information corresponding to a preset uttered voice for each of the at least one electronic device, wherein, when voice information regarding a voice uttered by a user is input through the input part after the second command is input, the controller may extract execution state information related to the voice information from the storage, and set the extracted execution state information to an event execution command matched to the event condition.

The portable terminal apparatus may further include a storage configured to store automation service information, wherein, when the event condition and the event execution command matched to the event condition are set, the controller may provide a registration completion message regarding automation service information including the event condition and the event execution command, and, when a user command is input, the controller may store the automation service information including the event condition and the event execution command in the storage.

When the automation service information including at least one of the event condition and the event execution command has not been previously stored, the controller may provide a message for newly registering the automation service information including the event condition and the event execution command, and, when automation service information including at least one of the event condition and the event execution command has been previously stored, the controller may provide a message inquiring as to whether to additionally register at least one of the event condition and the event execution command in the previously stored automation service information.

In a state in which the message related to new registration or additional registration is provided, when a new registration command is input, the controller may register and store the automation service information including the event condition and the event execution command in the storage, and in a state in which the message related to additional registration is provided, when an additional registration command is input, the controller may additionally register at least one of the event condition and the event execution command in the previously stored automation service information.

The controller may generate pattern information from a sensing value received from the at least one electronic device, and, when an event condition related to the generated pattern information has been previously stored, the controller may transmit a control command for controlling an operation of the at least one electronic device to the at least one electronic device on the basis of a stored event execution command matched to the previously stored event condition.

In accordance with another aspect of the present disclosure, a method for controlling a portable terminal apparatus is provided. The method includes, when a first user command is input, setting an event condition from a sensing value received from at least one electronic device, and, when a second user command is input, setting an event execution command matched to the event condition from the execution state information received from the at least one electronic device.

The setting of the event condition may include, when the first user command is input, determining an electronic device in which an event has occurred by analyzing a sensing value received from the at least one electronic device until a time that the second user command is input, generating pattern information from the sensing value received from the event-generated electronic device, and setting the generated pattern information to the event condition.

The setting of the event condition may include, when a user motion is input after the first user command is input, generating pattern information from the user motion, and setting the generated pattern information to the event condition.

The setting of the event condition may include, when voice information regarding a voice uttered by a user is input after the first user command is input, extracting condition information related to the voice information from a storage configured to store condition information corresponding to a preset uttered voice for each of the at least one electronic device, and setting the extracted condition information to the event condition.

The setting of the event execution command may include, when execution state information related to an operation execution of the at least one electronic device is received from the at least one electronic device within a preset threshold time after the second user command is input, setting an event execution command matched to the event condition from the received execution state information.

The setting of the event execution command may include, when voice information regarding a voice uttered by the user is received after the second user command is input, extracting execution state information related to the voice information from a storage configured to store execution state information corresponding to a preset uttered voice for each of the at least one electronic device, and setting the extracted execution state information to an event execution command matched to the event condition.

The method may further include, when the event condition and the event execution command matched to the event condition are set, providing a result regarding whether to finally set automation service information including the event condition and the event execution command, and registering the automation service information including the event condition and the event execution command according to a user command.

In the providing of the result regarding whether to finally set the automation service information, when the automation service information including at least one of the event condition and the event execution command has not been previously stored, a message for newly registering automation service information including the event condition and the event execution command may be provided, and, when automation service information including at least one of the event condition and the event execution command has been previously stored, a message inquiring as to whether to additionally register at least one of the event condition and the event execution command in the previously stored automation service information may be provided.

In the registering, when a new registration command is input in a state in which the message related to new registration or additional registration message is provided, the automation service information including the event condition and the event execution command may be newly registered, and, when an additional registration command is input in a state in which the additional registration related message is provided, at least one of the event condition and the event execution command may be additionally registered in the previously stored automation service information.

The method may further include transmitting a control command for controlling an operation of the at least one electronic device on the basis of a sensing value received from the at least one electronic device, wherein the transmitting of the control command may include generating pattern information from a sensing value received from the at least one electronic device, when an event condition related to the generated pattern information has been previously stored, obtaining a stored event execution command matched to the previously stored event condition, and transmitting a control command for controlling an operation of the at least one electronic device to the at least one electronic device on the basis of the obtained event execution command.

As described above, according to various embodiments of the present disclosure, the portable terminal apparatus may easily and quickly set IOT service related automation rule.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an automation service providing system according to an embodiment of the present disclosure;

FIG. 2 is a view illustrating a procedure of an automation service providing system according to an embodiment of the present disclosure;

FIG. 3 is a schematic block diagram of a portable terminal apparatus according to an embodiment of the present disclosure;

FIG. 4 is a block diagram of a portable terminal apparatus according to an embodiment of the present disclosure;

FIG. 5 is a flowchart illustrating a method of registering automation service information in a portable terminal apparatus according to an embodiment of the present disclosure;

FIG. 6 is a first flowchart illustrating a method of setting an event condition in a portable terminal apparatus according to an embodiment of the present disclosure;

FIG. 7 is a second flowchart illustrating a method of setting an event condition in a portable terminal apparatus according to an embodiment of the present disclosure;

FIG. 8 is a third flowchart illustrating a method of setting an event condition in a portable terminal apparatus according to an embodiment of the present disclosure;

FIG. 9 is a flowchart illustrating a method of registering automation service information in a portable terminal apparatus according to an embodiment of the present disclosure; and

FIG. 10 is a flowchart illustrating a method of controlling an operation of an electronic device on the basis of automation service information in a portable terminal apparatus according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Throughout the specification, like reference numerals denote the substantially same elements. For the purposes of description and understanding, the same reference numerals or symbols will be used in different various embodiments of the present disclosure and described. That is, although all the components are illustrated with the same reference numerals in a plurality of drawings, the plurality of drawings do not signify a single embodiment of the present disclosure.

In the present disclosure and claims, the ordinal terms first, second, etc. may be used to distinguish elements from each other. These ordinal terms are only used to distinguish the same or similar elements from each other, and meanings of terms should not be limited in interpretation due to the use of the ordinal terms. For example, elements combined with such ordinal terms should not be limited in usage order or disposition order by the number. If necessary, each ordinal numbers may be replaced to be used.

It will be further understood that terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

The terms “unit”, “part” and “module” described in the present disclosure mean components for processing at least one function and operation and can be implemented by hardware components or software components and combinations thereof. Also, a plurality of “modules”, “units”, and “parts” may be integrated into at least a single module or chip and implemented as at least one processor (not shown), except for a case in which each of them needs to be implemented as specific individual hardware.

It will be understood that, when an element is referred to as being “connected to” another element, it can be directly connected to the other element or intervening elements may also be present. In addition, unless explicitly described to the contrary, the word “comprise” and variations such as “comprises” or “comprising,” will be understood to imply the inclusion of stated elements but not the exclusion of any other elements.

Hereinafter, various embodiments of the present disclosure will be described with reference to the accompanying drawings.

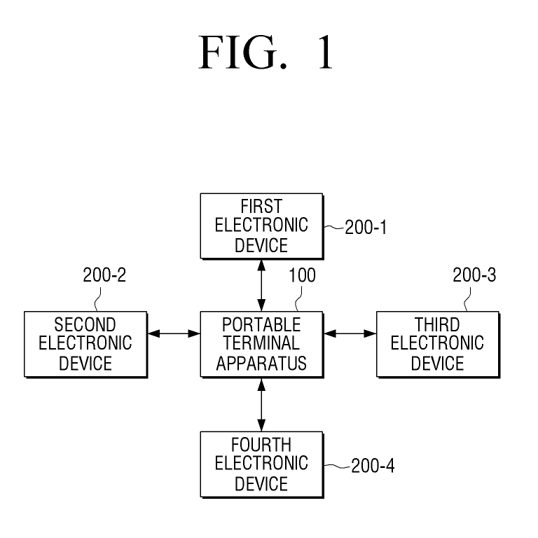

FIG. 1 is a block diagram of an automation service providing system according to an embodiment of the present disclosure.

Referring to FIG. 1, the automation service providing system includes a portable terminal apparatus 100 and an electronic device. Here, the electronic device may be any of first to fourth electronic devices 200-1 to 200-4.

The portable terminal apparatus 100 may set automation service information for controlling an operation of at least one of first to fourth electronic devices 200-1 to 200-4 according to a user command, and control an operation of at least one of the first to fourth electronic devices 200-1 to 200-4 on the basis of the set automation service information.

The portable terminal apparatus 100 may be an electronic device available for wireless communication such as a smartphone, a smart television (TV), a tablet personal computer (PC), or may be a hub device separately manufactured to control an operation of the first to fourth electronic devices 200-1 to 200-4.

The first to fourth electronic devices 200-1 to 200-4 may be provided in any of various locations such as a room, a kitchen, or a living room of a house to sense an event. For example, the first to fourth electronic devices 200-1 to 200-4 may be home appliances such as an air-conditioner, a refrigerator, a washing machine. However, the present disclosure is not limited thereto and the first to fourth electronic devices 200-1 to 200-4 may be a terminal device attached to furniture such as a sofa, a desk, or a closet.

The portable terminal apparatus 100 periodically performs data communication with the first to fourth electronic devices 200-1 to 200-4 to receive a detected sensing value from at least one of the first to fourth electronic devices 200-1 to 200-4, and sets an event condition for an automation service on the basis of the received sensing value. Thereafter, the portable terminal apparatus 100 sets an event execution command matched to a preset event condition on the basis of execution state information received from at least one of the first to fourth electronic devices 200-1 to 200-4.

In a state in which the event condition and event execution command are set, when a sensing value is received from at least one of the first to fourth electronic devices 200-1 to 200-4, the portable terminal apparatus 100 determines whether an event condition has been set in relation to the received sensing value. When an event condition has been set in relation to the received sensing value according to the determination result, the portable terminal apparatus 100 transmits a control command for controlling an operation of an electronic device to at least one of the first to fourth electronic devices 200-1 to 200-4 on the basis of the event execution command matched to a corresponding event condition. Thus, at least one of the first to fourth electronic devices 200-1 to 200-4 may perform a control operation on the basis of a control command received from the portable terminal apparatus 100.

According to embodiments of the present disclosure, an apparatus for setting automation service information is distinguished as the portable terminal apparatus 100 and a device performing an operation on the basis of the automation service information is distinguished as the first to fourth electronic devices 200-1 to 200-4. However, the present disclosure is not limited thereto and one of the first to fourth electronic devices 200-1 to 200-4 may be a device for setting automation service information. Also, in embodiments of the present disclosure, the portable terminal apparatus 100 is described to independently receive a user command for generating automation service information. However, the present disclosure is not limited thereto and the portable terminal apparatus 100 may receive a user command for generating automation service information through the fourth electronic device 200-4 available for voice recognition.

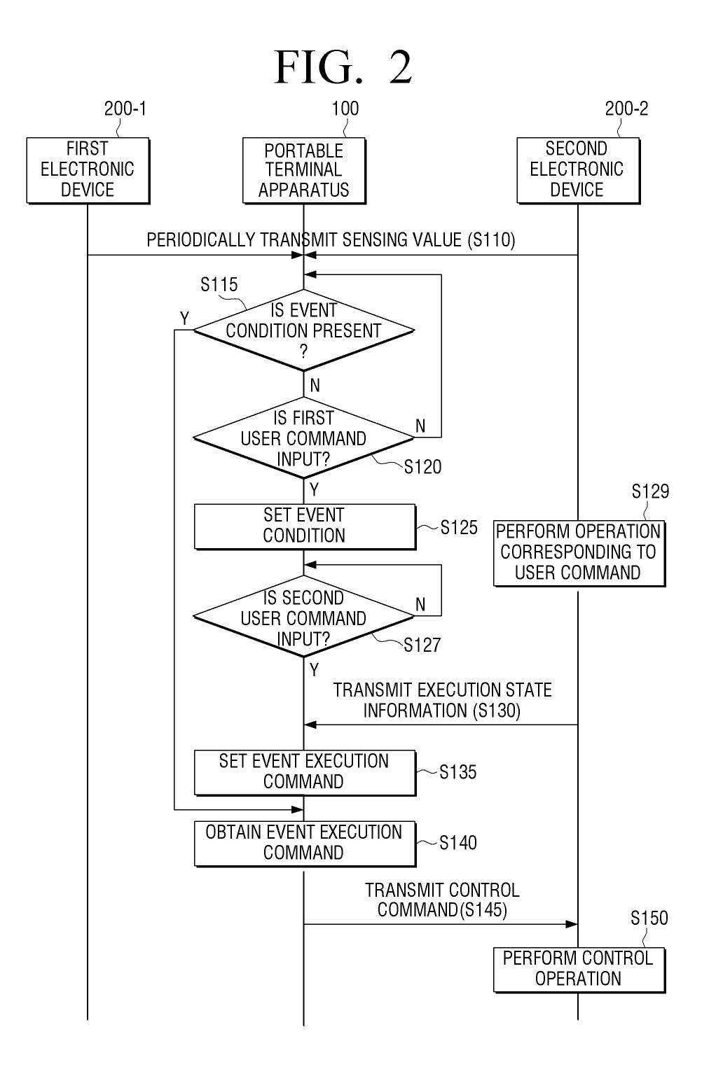

Hereinafter, the automation service providing system will be described with reference to FIG. 2.

FIG. 2 is a view illustrating a procedure of an automation service providing system according to an embodiment of the present disclosure.

Referring to FIG. 2, the first and second electronic devices 200-1 and 200-2 periodically detect an event situation, and transmit the detected sensing value to the portable terminal apparatus 100 in operation S110. Thus, the portable terminal apparatus 100 may temporarily store the sensing value received from at least one of the first and second electronic devices 200-1 and 200-2. Here, in order to prevent unnecessary sensing values from being stored in a recording medium such as a memory, the portable terminal apparatus 100 may delete sensing values temporarily stored during a preset threshold period of time from the recording medium.

When the sensing value is received from at least one of the first and second electronic devices 200-1 and 200-2, the portable terminal apparatus 100 determines whether a preset event condition has been stored in relation to the received sensing value in operation S115. For example, when a sensing value is received from at least one of the first and second electronic devices 200-1 and 200-2, the portable terminal apparatus 100 generates pattern information from the received sensing value, and determines whether event information related to the generated pattern information has already been set. The event condition will be described hereinafter.

When event information related to the pattern information generated from the received sensing value has not been set previously, the portable terminal apparatus 100 temporarily stores the pattern information generated from the sensing value received from at least one of the first and second electronic devices 200-1 and 200-2 in a recording medium such as a memory.

In this manner, in a state in which a sensing value is periodically received from at least one of the first and second electronic devices 200-1 and 200-2, when it is determined that a first user command is input in operation S120, the portable terminal apparatus 100 sets an event condition from a sensing value received from at least one of the first and second electronic devices 200-1 and 200-2 since the first user command was input in operation S125.

According to an embodiment of the present disclosure, after the first user command is input, the portable terminal apparatus 100 generates pattern information from a sensing value received from at least one of the first and second electronic devices 200-1 and 200-2. Thereafter, the portable terminal apparatus compares the generated pattern information with the temporarily stored pattern information to determine an electronic device, among the first and second electronic devices 200-1 and 200-2, in which an event has occurred.

For example, the first electronic device 200-1 may be a terminal device attached to a sofa to sense a weight, and the second electronic device 200-2 may be a smart TV. In this case, if an event that a user sits on the sofa is not sensed, the first electronic device 200-1 attached to the sofa may transmit a sensing value within a preset range to the portable terminal apparatus 100, and, when the second electronic device 200-2 such as a smart TV is maintained in a standby mode, the second electronic device 200-2 may transmit a sensing value within a preset range to the portable terminal apparatus 100.

After the user inputs a first user command, when the user sits on the sofa, the first electronic device 200-1 attached to the sofa may transmit a sensing value changed according to the event that the user sits on the sofa, to the portable terminal apparatus 100. Thus, the portable terminal apparatus 100 may compare the sensing value received from the first electronic device 200-1 among the first and second terminal devices 200-1 and 200-2, with a previously received sensing value and determine the first electronic device 200-1 as a device in which an event has occurred. In this manner, when the first electronic device 200-1 is determined as a device in which an event has occurred, the portable terminal apparatus 100 may obtain pattern information generated from the sensing value received from the first electronic device 200-1 as information for setting an event condition after the first user command is input

After it is determined that the first user command is input in operation S120 and the condition event is set in operation S125, the portable terminal apparatus 100 determines whether a second user command is input in operation S127. When a second user command is not input, the portable terminal apparatus 100 obtains pattern information generated from a sensing value received from the first electronic device 200-1 until a second user command is input.

When a second user command is input, the portable terminal apparatus 100 may determine pattern information, which has been obtained before a second user command is input since the first user command was input, as information for setting an event condition.

When an operation corresponding to a user command is performed according to the user command in operation S129, the second electronic device 200-2 may transmit execution state information related to the performed operation to the portable terminal apparatus 100 in operation S130.

For example, after the user inputs a second user command, the user may switch an operation mode of the second electronic device 200-2 in a standby mode to an activation mode. When the operation mode of the second electronic device 200-2 is switched to the activation mode according to the user command, the second electronic device 200-2 as a smart TV transmits execution state information according to the switching of the activation mode. Thus, after the second user command was input, when the execution state information is received from the second electronic device 200-2, the portable terminal apparatus 100 sets an event execution command for switching an operation mode of the second electronic device 200-2 to the activation mode on the basis of the received execution state information in operation S135. Thereafter, the portable terminal apparatus 100 may match the preset event condition and the preset event execution command and store the matched information.

Meanwhile, when it is determined that an event condition related to the sensing value received from at least one of the first and second electronic devices 200-1 and 200-2 has been set in operation S115, the portable terminal apparatus 100 obtains an event execution command matched to the corresponding event condition in operation S140. For example, an event condition related to the sensing value received from the first electronic device 200-1 may be set in advance. In this case, the portable terminal apparatus 100 transmits a control command to the second electronic device 200-2 on the basis of the event execution command matched to the preset event condition in operation S145. Accordingly, the second electronic device 200-2 in a deactivation mode may be switched to an activation mode on the basis of the control command received from portable terminal apparatus 100 and perform a control operation in operation S150.

In order to execute an automation service rule of “turn on TV when I sit on sofa”, as mentioned above, the user may input a first user command, make a move of sitting on a sofa, input a second user command, and subsequently turn on a smart TV. According to such a user behavior, the portable terminal apparatus 100 may generate automation service information including an event condition and an event execution command on the basis of the sensing value received from the first electronic device 200-1 and the execution state information received from the second electronic device 200-2, and store the generated automation service information.

After the automation service information is generated, when the user sits on the sofa, the portable terminal apparatus 100 transmits a power ON related control command to the second electronic device 200-2 as a smart TV on the basis of the event execution command included in the previously stored automation service information. Accordingly, the second electronic device 200-2 performs a power ON operation on the basis of the control command received from the portable terminal apparatus 100, whereby, when the user sits on the sofa, the automation service of performing power ON operation of the TV may be provided.

Hereinafter, exemplary components of the aforementioned portable terminal apparatus 100 will be described.

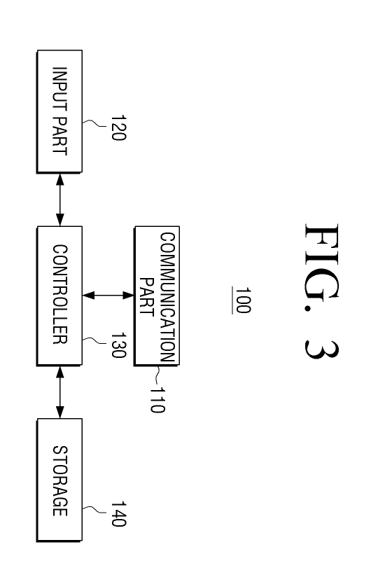

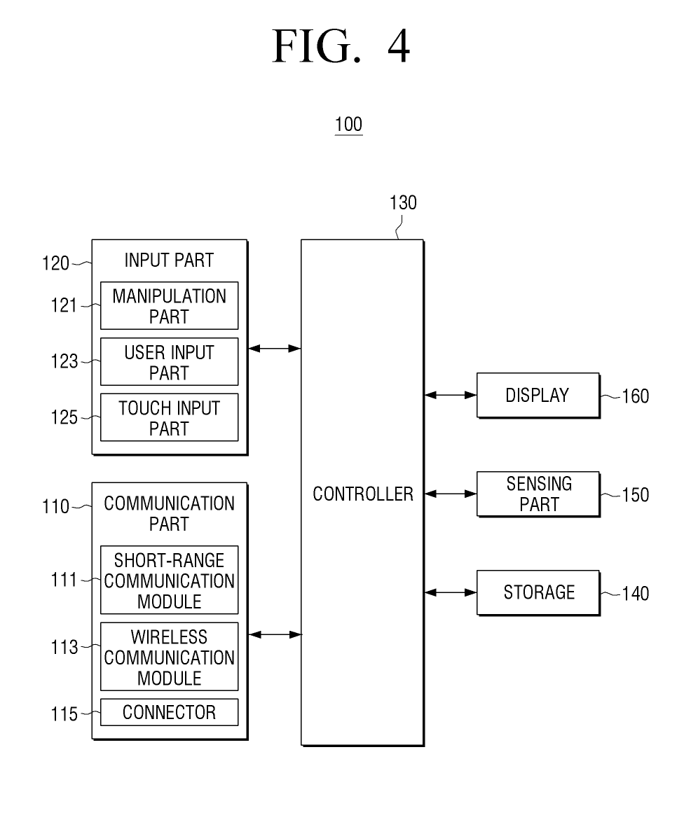

FIG. 3 is a schematic block diagram of a portable terminal apparatus according to an embodiment of the present disclosure, and FIG. 4 is a block diagram of a portable terminal apparatus according to an embodiment of the present disclosure.

Referring to FIG. 3, the portable terminal apparatus 100 may include a communication part 110, an input part 120, a controller 130, and a storage 140.

The communication part 110 may perform data communication with at least one of the first to fourth electronic devices 200-1 to 200-4 and receive a sensing value from at least one of the first to fourth electronic devices 200-1 to 200-4 or may receive execution state information. In addition, the communication part 110 may receive a user command for generating automation service information from at least one of the first to fourth electronic devices 200-1 to 200-4.

Referring to FIG. 4, the communication part 110 may include a short-range communication module 111, a wireless communication module 113 such as a wireless local area network (WLAN), and a connector 115 including at least one of a wired communication module such as a high-definition multimedia interface (HDMI), a universal serial bus (USB), and the Institute of Electrical and Electronics Engineers (IEEE) 1394.

The short-range communication module 111 is an element for performing short-range communication wirelessly between the portable terminal apparatus 100 and the electronic device 200. The short-range communication module 111 may include at least one of a Bluetooth module, an infrared data association (IrDA) module, a near field communication (NFC) module, a Wi-Fi module, and a ZigBee module.

The wireless communication module 113 is a module connected to an external network according to a wireless communication protocol such as the IEEE, or the like, to perform communication. In addition, the wireless communication module 113 may further include a mobile communication module connected to a mobile communication network according to various mobile communication standard such as 3^{rd} generation (3G), 3G partnership project (3GPP), and long term evolution (LTE) and performing communication.

In this manner, the communication part 110 may be implemented by various short-range communication schemes described above, and may employ other communication technique not mentioned in this disclosure as necessary.

The connector 115 is an element providing an interface with various source devices such as a USB 2.0, a USB 3.0, an HDMI, and connectors complying with the IEEE 1394 standard. The connector 115 may receive content data transmitted from an external server (not shown) through a fixed line cable connected to the connector 115 according to a control command from the controller 130 as described hereinafter, or may transmit already stored content data to an external recording medium. Also, the connector 115 may receive power from a power source through the fixed line cable physically connected to the connector 115.

The input part 120 is an input means for receiving various user commands and transferring the received user commands to the controller 130. As illustrated in FIG. 4, the input part may include a manipulation part 121 and a touch input part 125 receiving a user's manipulation command and a user input part 123 receiving a control signal corresponding to a user command from the fourth electronic device 200-4 described above.

Here, the manipulation part 121 may be implemented as a keypad having various function keys, number keys, special keys, and character keys, and, when a display 160 is implemented in the form of a touch screen, the touch input part 125 may be implemented as a touch pad having a layered structure with the display 160.

The user input part 123 may receive a user command for generating automation service information through a control signal such as an infrared (IR) signal or a radio frequency (RF) signal from the fourth electronic device 200-4. Also, when the fourth electronic device 200-4 is a remote control device (not shown) able to recognize a voice, the user input part 123 may receive a voice signal regarding a voice uttered by the user from the fourth electronic device 200-4, or may receive a user command such as a command for selecting a channel or a command for setting a function of the portable terminal apparatus 100.

The controller 130 generally controls an operation regarding each of the components constituting the portable terminal apparatus 100. For example, when a first user command is input through the input part 120, the controller 130 sets an event condition from a sensing value received from at least one of the first to fourth electronic devices 200-1 to 200-4. Here, the first user command may be a command for setting an event condition on the basis of a sensing value received from at least one of the first to fourth electronic devices 200-1 to 200-4. Also, the event condition may be a condition for determining whether to perform an automation service. In an embodiment of the present disclosure, the condition for determining whether to perform an automation service is termed an event condition, but the present disclosure is not limited thereto and the condition may also be termed a function condition or a service performing condition.

After the event condition is set, when a second user command is input through the input part 120, the controller 130 sets an event execution command matched to a preset event condition from execution state information received from at least one of the first to fourth electronic devices 200-1 to 200-4. Here, the second user command may be a command for setting an event execution command according to an operational state of the electronic device 200. Also, the event execution command may be an automation service-related command for automatically executing a specific function of at least one of the plurality of electronic devices. In an embodiment of the present disclosure, the automation service-related command is referred to as an event execution command, but the present disclosure is not limited thereto and may also be referred to as a function execution command or a service execution command. Also, execution state information received from at least one of the first to fourth electronic devices 200-1 to 200-4 may be information indicating a current operational state of the electronic device 200.

For example, the second electronic device 200-1 may be a smart TV, and may perform a power ON operation according to a user command. In this case, the second electronic device 200-1 may transmit execution state information according to the power ON operation to the portable terminal apparatus 100.

An embodiment of the present disclosure in which a first user command for setting an event condition is input after a second user command for setting an event execution command is input, as well as an embodiment of the present disclosure in which the second user command is input after the first user command is input, may be applied. The exemplary embodiment in which the second user command is input after the first user command is input will be described.

As described above, the storage 140 for storing automation service information including an event condition and an event execution command may store an operating system program for controlling an operation of the portable terminal apparatus 100. Here, the operating system program may be a program read from the storage 140 and compiled to operate each element of the portable terminal apparatus 100, when the portable terminal apparatus 100 is turned on. The storage 140 may be implemented as at least one of a read only memory (ROM), a random access memory (RAM), or a memory card (for example, a secure digital (SD) card or a memory stick), a non-volatile memory, a volatile memory, a hard disk drive (HDD), and a solid state drive (SSD) that can be attached to or detached from the portable terminal apparatus 100.

As described above, the portable terminal apparatus 100 may be at least one of first to fourth electronic devices 200-1 to 200-4. In this case, as illustrated in FIG. 4, the portable terminal apparatus 100 may further include a sensing part 150 and the display 160.

The sensing part 150 may periodically sense an event generated according to an operational state of the portable terminal apparatus 100. The sensing part 150 may include at least one of an accelerometer (not shown), a voice recognition sensor (not shown) sensing an audio signal generated in a surrounding environment, and a temperature sensor (not shown) sensing a temperature of a surrounding environment according to various embodiments of the present disclosure.

The display 160 may display data related to content received from an external server such as a content server (not shown) or data related to previously stored content, or display a user interface (UI) for controlling an operation of the portable terminal apparatus 100. The display 160 may be implemented as a liquid crystal display (LCD), an organic light emitting display (OLED), or a plasma display panel (PDP). For example, the display 160 may be implemented in the form of a touch screen forming a layered structure together with the touch input part 125.

Hereinafter, an embodiment of the present disclosure in which the portable terminal apparatus 100 according to an embodiment of the present disclosure sets an event condition will be described.

According to an embodiment of the present disclosure, when a first user command is input, the controller 130 analyzes a sensing value received from at least one of the first to fourth electronic devices 200-1 to 200-4 before a second user command is input, and determines the electronic device 200 in which an event has occurred. Thereafter, the controller 130 may set pattern information generated from the sensing value received from the electronic device 200 in which an event has occurred among the first to fourth electronic devices 200-1 to 200-4, as an event condition.

For example, the controller 130 may generate pattern information from sensing values periodically received from at least one of the first to fourth electronic devices 200-1 to 200-4 and temporarily store the generated pattern information in the storage 140, before a first user command is input. However, the present disclosure is not limited thereto and the controller 130 may temporarily store a sensing value received from at least one of the first to fourth electronic devices 200-1 to 200-4 in the storage 140.

In this manner, in a state in which the pattern information regarding sensing values periodically received from at least one of the first to fourth electronic devices 200-1 to 200-4 is temporarily stored in the storage 140, when a first user command is input, the controller 130 compares and analyzes pattern information regarding a sensing value received from at least one of the first to fourth electronic devices 200-1 to 200-4 after the first user command is input with pattern information previously stored in the storage 140 to determine whether there is pattern information in which an event has occurred.

For example, the user may request a first user command for setting an event condition through the input part 120 of the portable terminal apparatus 200 or the fourth electronic device 200-4 to which a user command related to automation service information setting may be input. Thereafter, the user may sit on a sofa to which the first electronic device 200-1 is attached. In this case, the first electronic device 200-1, which periodically senses a weight of the sofa and transmits the sensing value to the portable terminal apparatus 100, may transmit a sensing value changed according to the event in which the user sits on the sofa, to the portable terminal apparatus 100.

Thus, the controller 130 may determine that the first electronic device 200-1 is a device in which an event has occurred, on the basis of a variation of the sensing value received from the first electronic device 200-1 among the plurality of electronic devices 200. In this manner, when the first electronic device 200-1 is determined as an event-generated device, the controller 130 may obtain pattern information generated from the sensing value received from the first electronic device 200-1 after the first user command is input, as information for setting an event condition. Here, the controller 130 may obtain pattern information regarding a sensing value received from the first electronic device 200-1 and set the obtained pattern information as an event condition until a second user command for setting an event execution command is input.

That is, the controller 130 may set an event condition from the behavior that the user sits on the sofa.

After the user requests a first user command for setting an event, the user may sit on the sofa to which the first electronic device is attached, for a predetermined period of time, and makes a motion of picking up the third electronic device 200-3, such as a remote controller.

In this case, the first electronic device 200-1 may transmit a sensing value changed according to the event in which the user sits on the sofa, to the portable terminal apparatus 100, and the third electronic device 200-3 may transmit the sensing value changed according to the event in which the user picks up the third electronic device 200-3 to the portable terminal apparatus 100.

In this case, the controller 130 may determine the first and third electronic devices as devices in which an event has occurred, from variations between the sensing values received from the first and third electronic devices 200-1 and 200-3 before the first user command is input and sensing values received from the first and third electronic devices 200-1 and 200-3 after the first user command is input. In this manner, when the first and third electronic devices 200-1 and 200-3 are determined as devices in which an event has occurred, the controller 130 may obtain pattern information generated from the sensing values received from the first and third electronic devices 200-1 and 200-3 after the first user command is input, as information for setting an event condition. Here, the controller 130 may obtain pattern information regarding sensing values received from the first and third electronic devices 200-1 and 200-3 before a second user command for setting an event execution command is input, and set the obtained pattern information as an event condition.

That is, the controller 130 may set an event condition from the behavior of the user that sits on the sofa and from the behavior of the user that moves the remote controller.

Meanwhile, as described above, the controller 130 may set an event condition on the basis of behavior order in which the user moves the remote controller after sitting on the sofa. However, the present disclosure is not limited thereto and the controller 130 may set a condition in which each of the behaviors is conducted, as an event condition, regardless of order of the behaviors of the user that sits on the sofa and that moves the remote controller.

According to an embodiment of the present disclosure, after the first user command is input, when a user motion is input through the input part 130, the controller 130 may set pattern information generated from the input user motion, as an event condition.

For example, the user may request a first user command for setting an event condition through the fourth electronic device 200-4 to which an automation service information setting-related user command may be input. Thereafter, when the user makes a motion of moving the fourth electronic device 200-4, the fourth electronic device 200-4 transmits a sensing value sensed according to the user motion to the portable terminal apparatus 100. Accordingly, after the first user command is input, when the sensing value is received from the fourth electronic device 200-4, the controller 130 may generate pattern information from the received sensing value, and set the generated pattern information as an event condition.

That is, the controller 130 may set an event condition from the behavior of the user that moves the fourth electronic device 200-4.

According to an embodiment of the present disclosure, the storage 140 may store condition information corresponding to a preset uttered voice for each of at least one electronic device 200. In this case, after the first user command is input, when voice information regarding a voice uttered by the user is input through the input part 120, the controller 130 extracts condition information related to the input voice information among pieces of condition information previously stored in the storage 140. Thereafter, the controller 130 may set the extracted condition information as an event condition.

For example, the storage 140 may store condition information to which different sensing values are given in relation to objects such as “sit”, “lie”, and “stand” in relation to the sofa to which the first electronic device 200-1 is attached. For example, a sensing value 10 may be given to the object regarding “sit”, and a sensing value 15 may be given to the object of “lie”. Also, a sensing value 20 may be given to the object of “stand”.

Thus, when voice information related to a user uttered voice such as “when I sit on” is input from the fourth electronic device 200-4, the controller 130 may extract the object “sit” from the voice information regarding the uttered voice of “when I sit on” from the storage 140, and set the condition information (sensing value 10) set in relation to the extracted object, as an event condition.

When event conditions are set from various embodiments of the present disclosure, the controller 130 may set an event execution command according to a second user command of the user on the basis of various embodiments of the present disclosure.

According to an embodiment of the present disclosure, after the second user command is input, when execution state information related to an operation execution of the electronic device 200 is received from at least one of the first to fourth electronic devices 200-1 to 200-4 within a preset threshold time, the controller 130 may set an event execution command matched to a preset event condition from the received execution state information.

Meanwhile, in an embodiment of the present disclosure, a case in which execution state information related to an operation execution of the electronic device 200 is received from at least one of the first to fourth electronic devices 200-1 to 200-4 within a preset threshold time is described, but the present disclosure is not limited thereto and an event execution command may be set on the basis of execution state information received from at least one of the first to fourth electronic devices 200-1 to 200-4 before a third user command is input after the second user command is input, or an event execution command may be set on the basis of execution state information first received from at least one of the first to fourth electronic devices 200-1 to 200-4.

For example, the user may request a second user command for setting an event execution command through the fourth electronic device 200-4 or the input part 120 of the portable terminal apparatus 200 to which a user command related to automation information setting may be input. Thereafter, the user may transmit a power ON related control signal to the second electronic device 200-2 as a smart TV by using a remote control device (not shown) such as a remote controller, to the second electronic device 200-2 as a smart TV. Upon receiving the control signal the second electronic device 200-2 performs a power ON operation on the basis of the received control signal. When power of the second electronic device 200-2 is turned on and the second electronic device 200-2 enters an activation mode, the second electronic device 200-2 transmits execution state information according to the power ON operation to the portable terminal apparatus 100.

Thus, the controller 130 may set an event execution command related to power ON on the basis of the execution state information received from the second electronic device 200-2 among the plurality of electronic devices 200. When the event execution command is set, the controller 130 matches a preset event condition and a preset event execution command, and stores automation service information formed by matching the two types of information, in the storage 140.

That is, as in the example described above, the controller 130 may match the event condition set from the behavior of the user that sits on the sofa and the event execution command set from the event in which power of the second electronic device 200-2 as a smart TV is turned on, and store the automation service information obtained by matching the two types of information in the storage 140.

After the automation service information is registered and stored, when the user conducts a behavior of sitting on the sofa, the controller 130 transmits the power ON related control command to the second electronic device 200-2 as a smart TV on the basis of the event execution command included in previously stored automation service information. Accordingly, the second electronic device 200-2 performs power ON operation on the basis of the control command received from the portable terminal apparatus 100, whereby an automation service of performing a power ON operation of the TV when the user sits on the sofa is provided.

Meanwhile, after requesting the second user command for setting an event execution command, the user may transmit a power ON related control signal to the second electronic device 200-2 as a smart TV by using a remote control device (not shown) such as a remote controller. Also, the user may transmit a power ON related control signal to the third electronic device 200-3 such as an air-conditioner.

Upon receiving the control signal, the second electronic device 200-2 may perform a power ON operation on the basis of the received control signal, and transmits execution state information according to the power ON operation to the portable terminal apparatus 100. Also, upon receiving the control signal, the third electronic device 200-3 performs a power ON operation on the air-conditioner on the basis of the received control signal, and transmits execution state information according to the power ON operation to the portable terminal apparatus 100.

Thus, the controller 130 may set a power ON related event execution command on the basis of each execution state information received from the second and third electronic devices 200-2 and 200-3 among the plurality of electronic devices 200. When the event execution command is set, the controller 130 may match the preset event condition and the present event execution command, and store automation service information obtained by matching the two types of information in the storage 140.

That is, as in the example described above, the controller 130 may match an event condition set from a behavior of the user that sits on a sofa and an event execution command set from an event in which power of the second and third electronic devices are turned on, and store the automation service information obtained by matching the two types of information in the storage 140.

After the automation service information is registered and stored, when the user conducts the behavior of sitting on the sofa, the controller 130 transmits power ON related control command to the second and third electronic devices 200-2 and 200-3 on the basis of the event execution command included in the previously stored automation service information. Accordingly, the second and third electronic devices 200-2 and 200-3 perform power ON operation on the basis of the control command received from the portable terminal apparatus 100, whereby the automation service of performing power ON operation of the smart TV and the air-conditioner may be provided when the user sits on the sofa.

According to an embodiment of the present disclosure, the storage 140 may store execution information corresponding to a preset uttered voice for each of at least one electronic device 200. In this case, after the second user command is input, when voice information regarding a voice uttered by the user is received through the input part 120, the controller 130 extracts execution information related to the previously received voice information from the storage 140. Thereafter, the controller 130 sets the extracted execution information as an event execution command Thereafter, the controller 130 matches a preset event condition and a preset event execution command, and stores automation service obtained by matching the two types of information in the storage 140.

For example, the storage 140 may store execution information related to an object such as “power on/off”, “volume up/down”, and “channel up/down” in relation to the second electronic device 200-2 as a smart TV. Thus, when the voice information related to the user-uttered voice of “power on” is input from the fourth electronic device 200-4, the controller 130 may extract execution information from the voice information regarding the uttered voice of “power on” from the storage 140, and set the extracted execution information as an event execution command.

According to an additional aspect of the present disclosure, when an event condition and an event execution command are set on the basis of a user behavior, the controller 130 may determine whether to register and store the automation service information including the preset event condition and event execution command on the basis of the following embodiment of the present disclosure.

According to an embodiment of the present disclosure, the controller 130 determines whether automation service information including at least one of the event condition and the event execution command has been stored in the storage 140. When automation service information including at least one of the event condition and the event execution command that has been stored in the storage 140 has not been stored in the storage 140 according to the determination result, the controller 130 may provide a message to newly register automation service information including the event condition and the event execution command that has been stored in the storage 140, through the display 160.

When a new registration command is input in a state in which the message is displayed, the controller 130 may store the automation service information including the event condition and the event execution command and store the same in the storage 140.

Meanwhile, when the automation service information including at least one of the event condition and the event execution command has been stored, the controller 130 may provide a message indicating whether to additionally register at least one of the event condition and the event execution command in the previously stored automation service information, through the display 160.

In a state in which the message is displayed, when a new registration command is input, the controller 130 may newly register automation service information including the event condition and the event execution command and store the same in the storage 140.

Meanwhile, in a state in which the message inquiring about whether to newly register the automation service information is displayed, when an additional registration command is input, the controller 130 may additionally register at least one of the event condition and event execution command in the previously stored automation service information and store the same in the storage 140.

For example, first automation service information, among a plurality of pieces of automation service information stored in the storage 140, may include an event condition “A” and an event execution command “a”. Meanwhile, a preset event condition may be a condition “A” and a preset event execution command may be an execution command “b”. In this case, the preset event condition may correspond to the event condition of the previously stored first automation service information. In this manner, in a state in which the event condition of the previously stored first automation service information and the preset event condition are the same, when an additional registration command is input, the controller 130 additionally registers the preset event execution command in the first automation service information. Thus, the first automation service information may include the event condition “A”, the event execution command “a”, and an event execution command “c”.

Thus, when the user performs an operation related to the event condition “A”, the controller 130 may transmit a control command to the electronic device 200 related to the event execution command “a” and the event execution command “c” on the basis of the event execution command “a” and the event execution command “c”.

Meanwhile, as mentioned above, at least one of the first to fourth electronic devices 200-1 to 200-4 transmits a periodically sensed sensing value to the portable terminal apparatus 100. Thus, when a sensing value is received from at least one of the first to fourth electronic devices 200-1 to 200-4, the controller 130 generates pattern information from the received sensing value. When pattern information is generated from the sensing value, the controller 130 determines whether automation service information including an event condition related to previously generated pattern information among event conditions included in a plurality of pieces of automation service information previously stored in the storage 140 has been stored. When automation service information including an event condition related to previously generated pattern information has been stored according to the determination result, the controller 130 obtains an event execution command matched to the corresponding event condition from the automation service information including an event condition related to the previously generated pattern information. Thereafter, the controller 130 transmits a control command for controlling an operation of the electronic device to at least one of the first to fourth electronic devices 200-1 to 200-4 on the basis of the obtained event execution command.

Accordingly, at least one electronic device 200 among the first to fourth electronic devices 200-1 to 200-4 may execute an operation corresponding to the control command received from the portable terminal apparatus 100.

Various elements of the portable terminal apparatus 100 providing an automation service according to an embodiment of the present disclosure have been described. Hereinafter, a control method for providing an automation service in the portable terminal apparatus 100 will be described.

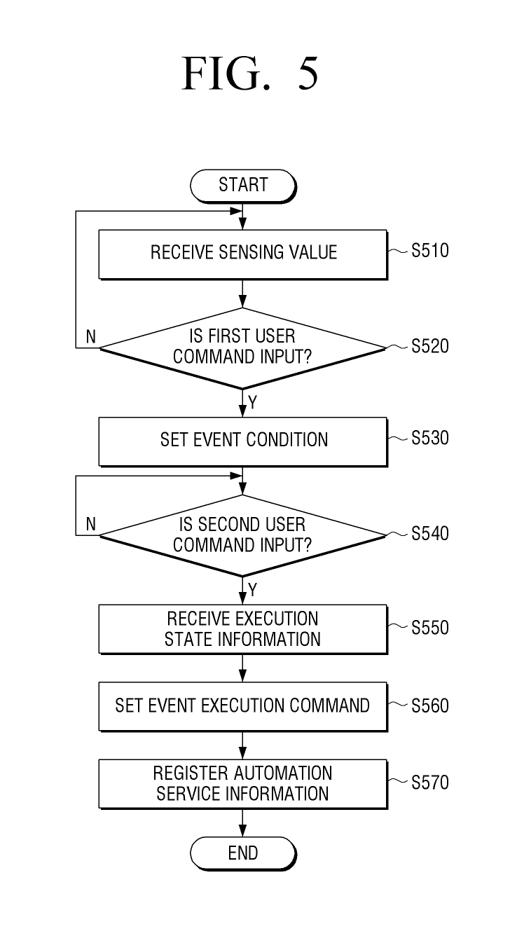

FIG. 5 is a flowchart illustrating a method of registering automation service information in a portable terminal apparatus according to an embodiment of the present disclosure.

Referring to FIG. 5, the portable terminal apparatus 100 receives a periodically sensed sensing value from at least one of a plurality of electronic devices 100 in operation S510. In a state in which the sensing value is received, when a first user command is input, the portable terminal apparatus 100 sets an event condition from a sensing value received from at least one of the plurality of electronic devices 200 after the first user command is input in operations S520 and S530. Here, the first user command may be a command for setting an event condition on the basis of the sensing value received from at least one of the first to fourth electronic devices 200-1 to 200-4.

Thereafter, when a second user command is input, the portable terminal apparatus 100 sets an event execution command matched to an event condition from execution state information indicating an execution state of the electronic device 200 among pieces of information received from the at least one electronic device 200 after the second user command is input in operations S540 and S550. Here, the second user command may be a command for setting an event execution command according to an operational state of the electronic device 200. The execution state information received from the at least one electronic device 200 may be information indicating a current operational state of the electronic device 200.

For example, the second electronic device 200-1, among the plurality of electronic devices 200, may be a smart TV, and may perform a power ON operation according to a user command. In this case, the second electronic device 200-1 may transmit execution state information according to the power ON operation to the portable terminal apparatus 100. When the execution state information is received from the second electronic device 200-1, the portable terminal apparatus 100 may set an event execution command matched to a preset event condition from the received execution state information in operation S560.

Thereafter, the portable terminal apparatus 100 registers and stores automation service information including a preset event condition and an event execution command matched to the corresponding event condition in operation S570.

Hereinafter, a method for setting an event condition in the portable terminal apparatus 100 according to an embodiment of the present disclosure will be described.

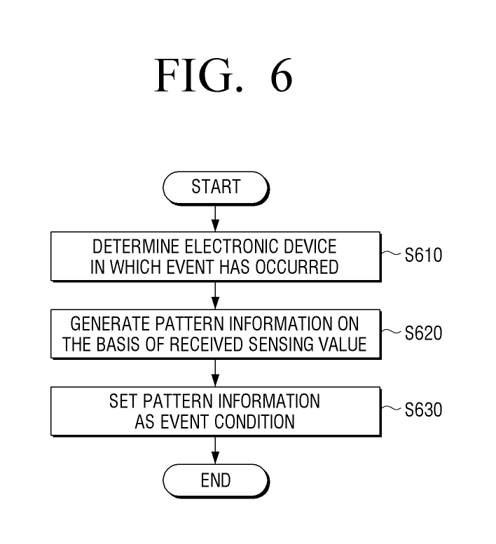

FIG. 6 is a first flowchart illustrating a method of setting an event condition in a portable terminal apparatus according to an embodiment of the present disclosure.

Referring to FIG. 6, when a first user command is input, the portable terminal apparatus 100 analyzes a sensing value received from at least one of a plurality of electronic devices 200 until a time that the first user command is input, and determines an electronic device 200 in which an event has occurred in operation S610. Thereafter, the portable terminal apparatus 100 generates pattern information from the sensing value received from the electronic device 200 in which an event has occurred, among the plurality of electronic devices 200, and sets the generated pattern information as an event condition in operations S620 and S630.

For example, the portable terminal apparatus 100 stores a sensing value received from at least one of the plurality of electronic devices 200 until the first user command is input. In this manner, in a state in which the sensing value received from at least one of the electronic devices 200 is stored, when a first user command is input, the portable terminal apparatus 100 may compare and analyze the sensing value received from the at least one electronic device 200 after the first user input is input, with a previously stored sensing value to extract a sensing value in which an event has occurred, and generate pattern information to be set as an event condition from the extracted sensing value.

However, the present disclosure is not limited thereto and the portable terminal apparatus 100 may store pattern information generated from the sensing value received from at least one of the plurality of electronic devices 200. In this case, in a state in which the first user command is input, when a sensing value is received from at least one electronic device 200 after the first user command is input, the portable terminal apparatus 100 generates pattern information from the received sensing value and compares the generated pattern information with previously stored pattern information to extract pattern information in which an event has occurred.

In this manner, when the pattern information in which an event has occurred is generated or extracted, the portable terminal apparatus 100 may determine the electronic device 200 which has transmitted the sensing value related to the corresponding pattern information as a device in which an event has occurred, and obtains pattern information generated from the sensing value received from the electronic device 200 determined as an event-generated device, as information for setting an event condition. Here, the portable terminal apparatus 100 may obtain pattern information regarding a sensing value received from the electronic device 200 determined as the event-generated device until a time that a second user command for setting an event execution command is input, and set the obtained pattern information as an event condition.

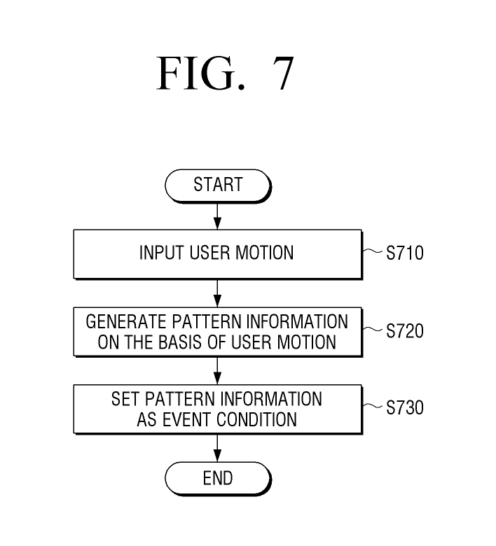

FIG. 7 is a second flowchart illustrating a method of setting an event condition in a portable terminal apparatus according to an embodiment of the present disclosure.

Referring to FIG. 7, after a first user command is input, when a user motion is input, the portable terminal apparatus 100 generates pattern information from the input user motion in operations S710 and S720. Thereafter, the portable terminal apparatus 100 sets the pattern information generated from the user motion, to an event condition in operation S730.

For example, the user may request a first user command for setting an event condition through the fourth electronic device 200-4 to which a user command related to automation service information setting may be input. Thereafter, when the user makes a motion of moving the fourth electronic device 200-4, the fourth electronic device 200-4 transmits a sensing value sensed according to the user motion to the portable terminal apparatus 100. Thus, after the first user command is input from the fourth electronic device 200-4, when the sensing value according to the user motion is received, the portable terminal apparatus 100 may generate pattern information from the received sensing value and set the generated pattern information as an event condition.

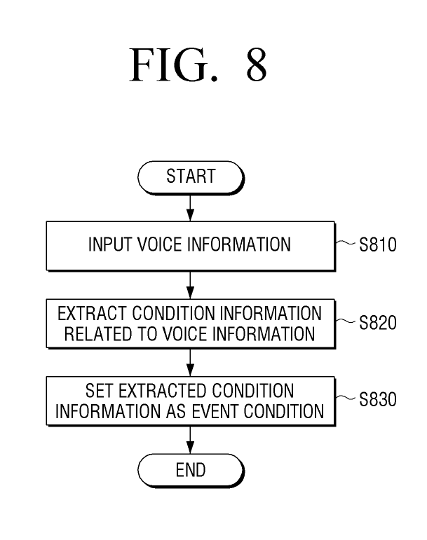

FIG. 8 is a third flowchart illustrating a method of setting an event condition in a portable terminal apparatus according to an embodiment of the present disclosure.

Referring to FIG. 8, after the first user command is input, when voice information regarding a voice uttered by the user is input, the portable terminal apparatus 100 extracts condition information related to the input voice information from the storage storing the condition information corresponding to an uttered voice previously set in each of at least one electronic device 200 in operations S810 and S820. Thereafter, the portable terminal apparatus 100 sets the extracted condition information as an event condition in operation S830.

For example, the portable terminal apparatus 100 may store condition information to which different sensing values are given in relation to objects such as “sit”, “lie”, and “stand” in relation to the sofa to which the first electronic device 200-1 is attached, in the storage in advance. For example, a sensing value 10 may be given to the object regarding “sit”, and a sensing value 15 may be given to the object of “lie”. Also, a sensing value 20 may be given to the object of “stand”.

Thus, when voice information related to a user uttered voice such as “when I sit on sofa” is input from the fourth electronic device 200-4, the portable terminal apparatus 100 may extract the object “sit” from the voice information regarding the uttered voice of “when I sit on sofa” from the storage 140, and sets the condition information (sensing value 10) set in relation to the extracted object, as an event condition.

When event conditions are set from various embodiments of the present disclosure, the portable terminal apparatus 100 may set an event execution command according to a second user command of the user on the basis of the following various embodiments of the present disclosure.

According to an embodiment of the present disclosure, after the second user command is input, when execution state information related to an operation execution of the electronic device 200 is received from at least one electronic devices 200 within a preset threshold time, the portable terminal apparatus 100 may set an event execution command matched to a preset event condition from the received execution state information.

According to an embodiment of the present disclosure, after the second user command is input, when voice information regarding a voice uttered by the user is input, the portable terminal apparatus 100 extracts execution state information related to previously input voice information from the storage storing execution state information corresponding to a preset uttered voice for each of at least one electronic device 200. Thereafter, the portable terminal apparatus 100 may set the extracted execution state information as an event execution command matched to the preset event condition.

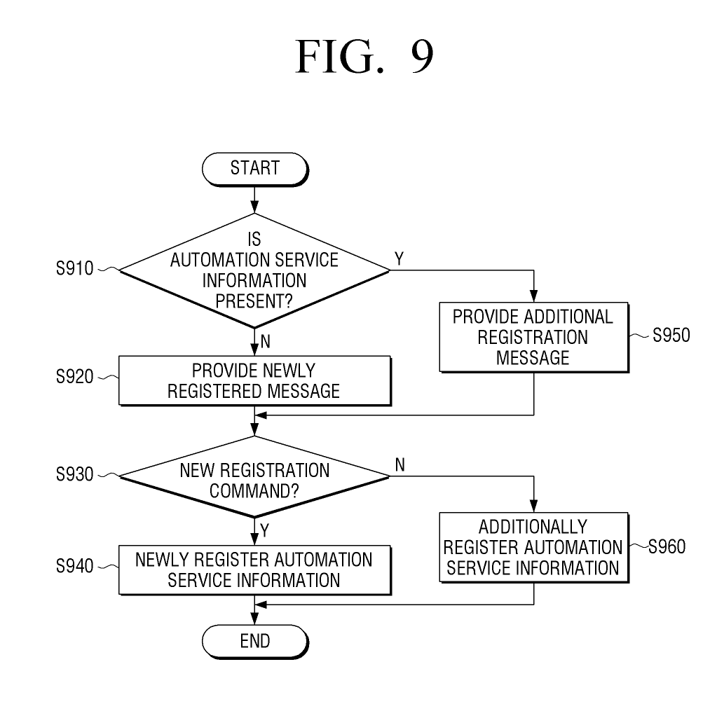

FIG. 9 is a flowchart illustrating a method of registering automation service information in a portable terminal apparatus according to an embodiment of the present disclosure.

Referring to FIG. 9, the portable terminal apparatus 100 determines whether automation service information including at least one of an event condition and an event execution command has been stored in a storage in operation S910. When automation service information including at least one of the event condition and the event execution command has not been stored in the storage according to the determination result, the portable terminal apparatus 100 provides a message for newly registering the automation service information including the event condition and the event execution command in operation S920.

In a state in which the message is displayed, it is determined whether a new registration command is input, and, when a new registration command is input, the portable terminal apparatus 100 newly registers the automation service information including the event condition and the event execution command and stores the same in the storage in operations S930 and S940.

Meanwhile, when it is determined that the automation service information including at least one of the event condition and the event execution command has been previously stored in operation S910, the portable terminal apparatus 100 provides a message inquiring as to whether to additionally register at least one of the event condition and the event execution command in the previously stored automation service information in operation S950. In a state in which the message is displayed, when a new registration command is input, the portable terminal apparatus 100 may newly register the automation service information including the event condition and the event execution command and store the same in the storage on the basis of operation S940 described above.

Meanwhile, in a state in which the message inquiring as to whether to additionally register the at least one of the event condition and the event execution command in the previously stored automation service information is displayed in operation S950, when an additional registration command is input, the portable terminal apparatus 100 additionally registers at least one of the event condition and the event execution command in the previously stored automation service information and store the same in the storage in operation S960.

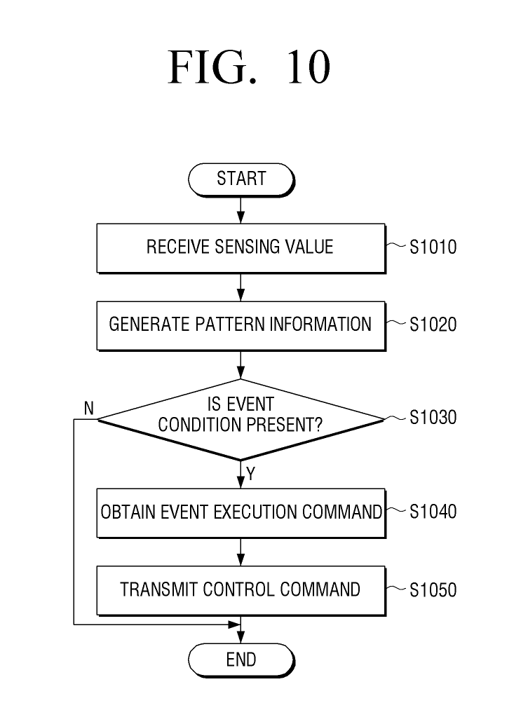

FIG. 10 is a flowchart illustrating a method of controlling an operation of an electronic device on the basis of automation service information in a portable terminal apparatus according to an embodiment of the present disclosure.

Referring to FIG. 10, when a sensing value is received from at least one of the plurality of electronic devices 200, the portable terminal apparatus 100 generates pattern information from the received sensing value in operations S1010 and S1020. When the pattern information is generated from the received sensing value, the portable terminal apparatus 100 determines whether automation service information including an event condition related to previously generated pattern information, among event conditions included in a plurality of pieces of previously stored automation service information, has been stored in operation S1030. When the automation service information including an event condition related to the previously generated pattern information has been stored according to the determination result, the portable terminal apparatus 100 obtains an event execution command matched to the corresponding event condition from the automation service information including the event condition related to the previously generated pattern information in operation S1040. Thereafter, the portable terminal apparatus 100 transmits a control command for controlling an operation of the electronic device 200 to at least one of the plurality of electronic devices 100 on the basis of the obtained event execution command in operation S1050.

Accordingly, at least one of the plurality of electronic devices 200 may execute an operation corresponding to the control command received from the portable terminal apparatus 100.

The portable terminal apparatus and control method according to various embodiments of the present disclosure described above may be implemented in a program so as to be provided to the display apparatus. For example, the program including the portable terminal apparatus and control method may be stored and provided in a non-transitory computer readable medium.

The non-transitory computer readable medium does not mean a medium storing data for a short period such as a register, a cache, a temporary memory, or the like, but means a machine-readable medium semi-permanently storing the data. Specifically, various applications or programs described above may be stored and provided in the non-transitory computer readable medium such as a compact disc (CD), a digital versatile disc (DVD), a hard disk, a Blu-ray disk, a USB, a memory card, a ROM, or the like.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A portable terminal apparatus comprising:
a communication part configured to perform data communication with at least one electronic device;
an input part configured to receive a user command; and
a controller configured to:
set an event condition from a sensing value received from the at least one electronic device when a first user command is input through the input part, and
set an event execution command matched to the event condition from execution state information received from the at least one electronic device when a second user command is input through the input part.

2. The portable terminal apparatus of claim 1, wherein, when the first user command is input, the controller is further configured to:
analyze the sensing value received from the at least one electronic device until a time that the second user command is input,
determine an electronic device in which an event has occurred, and
set pattern information generated from a sensing value received from the electronic device in which the event has occurred, to the event condition.

3. The portable terminal apparatus of claim 1, wherein after the first user command is input, when a user motion is input through the input part, the controller is further configured to set pattern information generated from the user motion to the event condition.

4. The portable terminal apparatus of claim 1, further comprising:
a storage configured to store condition information corresponding to a preset uttered voice for each of the at least one electronic device,
wherein, when voice information regarding a voice uttered by a user is input through the input part after the first user command is input, the controller is further configured to:
extract condition information related to the voice information from the storage, and
set the extracted condition information to the event condition.

5. The portable terminal apparatus of claim 1, wherein when execution state information related to an operation execution of an electronic device is received from the at least one electronic device within a preset threshold time after the second user command is input, the controller is further configured to set an event execution command matched to the event condition from the received execution state information.

6. The portable terminal apparatus of claim 1, further comprising:
a storage configured to store execution state information corresponding to a preset uttered voice for each of the at least one electronic device,
wherein, when voice information regarding a voice uttered by a user is input through the input part after the second command is input, the controller is further configured to:
extract execution state information related to the voice information from the storage, and
set the extracted execution state information to an event execution command matched to the event condition.

7. The portable terminal apparatus of claim 1, further comprising:
a storage configured to store automation service information,
wherein when the event condition and the event execution command matched to the event condition are set, the controller is further configured to provide a registration completion message regarding automation service information including the event condition and the event execution command, and
when a user command is input, the controller is further configured to store the automation service information including the event condition and the event execution command in the storage.

8. The portable terminal apparatus of claim 7, wherein,
when the automation service information including at least one of the event condition and the event execution command has not been previously stored, the controller is further configured to provide a message for newly registering the automation service information including the event condition and the event execution command, and
when automation service information including at least one of the event condition and the event execution command has been previously stored, the controller is further configured to provide a message inquiring as to whether to additionally register at least one of the event condition and the event execution command in the previously stored automation service information.

9. The portable terminal apparatus of claim 8, wherein,
in a state in which the message related to new registration or additional registration is provided, when a new registration command is input, the controller is further configured to register and store the automation service information including the event condition and the event execution command in the storage, and
in a state in which the message related to additional registration is provided, when an additional registration command is input, the controller is further configured to additionally register at least one of the event condition and the event execution command in the previously stored automation service information.

10. The portable terminal apparatus of claim 1, wherein,
the controller is further configured to generate pattern information from a sensing value received from the at least one electronic device, and
when an event condition related to the generated pattern information has been previously stored, the controller is further configured to transmit a control command for controlling an operation of the at least one electronic device to the at least one electronic device on the basis of a stored event execution command matched to the previously stored event condition.

11. A method for controlling a portable terminal apparatus, the method comprising:
when a first user command is input, setting an event condition from a sensing value received from at least one electronic device; and
when a second user command is input, setting an event execution command matched to the event condition from the execution state information received from the at least one electronic device.

12. The method of claim 11, wherein the setting of the event condition includes:
when the first user command is input, determining an electronic device in which an event has occurred by analyzing a sensing value received from the at least one electronic device until a time that the second user command is input;
generating pattern information from the sensing value received from the event-generated electronic device; and
setting the generated pattern information to the event condition.

13. The method of claim 11, wherein the setting of the event condition includes:
when a user motion is input after the first user command is input, generating pattern information from the user motion; and
setting the generated pattern information to the event condition.

14. The method of claim 11, wherein the setting of the event condition includes:
when voice information regarding a voice uttered by a user is input after the first user command is input, extracting condition information related to the voice information from a storage configured to store condition information corresponding to a preset uttered voice for each of the at least one electronic device; and
setting the extracted condition information to the event condition.

15. The method of claim 11, wherein the setting of the event execution command includes:
when execution state information related to an operation execution of the at least one electronic device is received from the at least one electronic device within a preset threshold time after the second user command is input, setting an event execution command matched to the event condition from the received execution state information.

16. The method of claim 11, wherein the setting of the event execution command includes:
when voice information regarding a voice uttered by the user is received after the second user command is input, extracting execution state information related to the voice information from a storage configured to store execution state information corresponding to a preset uttered voice for each of the at least one electronic device; and
setting the extracted execution state information to an event execution command matched to the event condition.

17. The method of claim 11, further comprising:
when the event condition and the event execution command matched to the event condition are set, providing a result regarding whether to finally set automation service information including the event condition and the event execution command; and
registering the automation service information including the event condition and the event execution command according to a user command.

18. The method of claim 17, wherein, in the providing of the result regarding whether to finally set the automation service information,
when the automation service information including at least one of the event condition and the event execution command has not been previously stored, a message for newly registering automation service information including the event condition and the event execution command may be provided, and
when automation service information including at least one of the event condition and the event execution command has been previously stored, a message inquiring as to whether to additionally register at least one of the event condition and the event execution command in the previously stored automation service information may be provided.

19. The method of claim 18, wherein, in the registering,
when a new registration command is input in a state in which the message related to new registration or additional registration is provided, the automation service information including the event condition and the event execution command may be newly registered, and
when an additional registration command is input in a state in which the additional registration related message is provided, at least one of the event condition and the event execution command may be additionally registered in the previously stored automation service information.

20. The method of claim 11, further comprising:
transmitting a control command for controlling an operation of the at least one electronic device on the basis of a sensing value received from the at least one electronic device,
wherein the transmitting of the control command includes:
generating pattern information from a sensing value received from the at least one electronic device;
when an event condition related to the generated pattern information has been previously stored, obtaining a stored event execution command matched to the previously stored event condition; and
transmitting a control command for controlling an operation of the at least one electronic device to the at least one electronic device on the basis of the obtained event execution command.
